(19) United States
(12) Patent Application Publication
(10) Pub. No.: US 2013/0021609 A1
(43) Pub. Date: Jan. 24, 2013

(54) MODULATED ELLIPSOMETER FOR THE DETERMINATION OF THE PROPERTIES OF OPTICAL MATERIALS

(71) Applicants: Yu-Lung LO, Tainan (TW); Shiou-An TSAI, Tainan (TW)

(72) Inventors: Yu-Lung LO, Tainan (TW); Shiou-An TSAI, Tainan (TW)

(73) Assignee: NATIONAL CHENG KUNG UNIVERSITY, Tainan City (TW)

(21) Appl. No.: 13/188,313

(22) Filed: Jul. 21, 2011

(51) Int. Cl. G01J 4/04

(52) U.S. Cl. 356/369

(57) ABSTRACT

An ellipsometer for determining thickness and ellipsometric parameters (Ψ and Δ) of a thin film material. The apparatus includes a light source emitting light, a transmitting optical system that has a polarizer, modulator and an optical compensator for conveying polarized modulated light for incidence on a film, and a receiving optical system that has an analyzer and conveys the reflected light to a photodetector device. The apparatus is used for full range measurement of ellipsometric parameters by applying two-phase detection method. It also determines thickness of thin films with a high degree of accuracy.

### FIELD

Exemplary embodiments relate to ellipsometry, and, more particularly, to a system and method for determining ellipsometric parameters and thickness of thin films.

### BACKGROUND

Ellipsometry is a related art optical technique that uses polarized light to probe the properties of a sample. Ellipsometry has applications in many different fields which may include but are not limited to semiconductor physics, microelectronics and biology, and further applications that may pertain to but are not limited to basic research and industrial applications. Ellipsometry is a sensitive measurement technique and provides unequalled capabilities for thin film metrology. To be useful, the measurement system must be able to determine the thickness of films with a high degree of accuracy.

In related art elipsometric methods, incident polarized light is made to fall on the film whose thickness has to be measured and the reflected light is received by the photodetector for phase detection and calculation of ellipsometric parameters and thickness of film. Errors in measurement result from slight imperfections in the optical elements within the measurement system, or may be caused by misalignment errors when constructing the measurement platform. If the individual optical elements of the modulated ellipsometry are not perfectly aligned, the resulting elliptical polarized state of the light cause phase errors. Moreover, the non-perfect sinusoidal retardance variation of the modulator may induce errors in the subsequent demodulation signal processing procedure.

Further, these related art methods depend on amplitude and/or intensity of the detected signal for determination of thickness of thin films. The amplitude and/or intensity is/are affected by environmental disturbances and optical misalignments. Thus, using these related methods would not be suitable for accurate determination of ellipsometric parameters and thickness of thin film.

Thus, there is an unmet need for an improved system and method for accurate determination of ellipsometric parameters and thickness of thin films.

### SUMMARY

Aspects of the exemplary embodiments relate to measuring thickness of thin film with high accuracy using a modulated ellipsometric apparatus.

It is an object of the exemplary embodiments to achieve full range-measurement of ellipsometric parameters with high accuracy using a two-phase detection method.

It is another object of the exemplary embodiments to determine properties including but not limited to stress, strain, thickness, refractive indices, dielectric constants, magneto-optical parameters.

It is still another object of the exemplary embodiments to measure optical material properties including but not limited to pre-tilt angle, tilt angle, azimuth angle and phase retardation of liquid crystal displays and birefringence materials.

It is still another object of the exemplary embodiments to provide spectroscopic, in-situ, image measurement for isotropic multilayer material.

It is still another object of the exemplary embodiments to provide dynamic measurement of properties of sample including but not limited to measuring properties of sample when sample is vibrating.

It is still another object of the exemplary embodiments to provide a modulated ellipsometer for thin film thickness measurement. The modulated ellipsometer comprising: a light source; a polarizer for polarizing the light received from the light source; a modulator for modulating the polarized light; an optical compensator for altering the polarization state of light received from the modulator and directing light onto the sample; an analyzer for polarizing the reflected light received from the sample; a detector for receiving light from the analyzer for two-phase detection corresponding to two different orientations of the optical compensator.

It is still another object of the exemplary embodiments to provide a method for thin film thickness measurement. The method comprising: emitting light from a light source; polarizing the light from the light source; modulating the polarized light; altering the polarization state of the light received from the modulator and directing the light onto the sample; polarizing the reflected light received from the sample using an analyzer; receiving the light from the analyzer for two-phase detection corresponding to two different orientations of the optical compensator.

### BRIEF DESCRIPTION OF THE DRAWINGS

FIG. 1 shows the ellipsometric apparatus 100 in accordance with an exemplary embodiment;

FIG. 2 illustrates a first exemplary configuration of the ellipsometric apparatus 100;

FIG. 3 illustrates a second exemplary configuration of the ellipsometric apparatus 100;

FIG. 4 illustrates an exemplary optical model for an ambient/thin film/substrate structure;

FIG. 5 is a graph showing an exemplary ellipsometric parameter Ψ result of the simulation;

FIG. 6 is a graph showing an exemplary ellipsometric parameter Δ result of the simulation;

FIG. 7 is a graph showing an exemplary first phase Φ₁ result of the simulation;

FIG. 8 is a graph showing an exemplary second phase Φ₂ result of the simulation;

FIG. 9 is a graph showing an exemplary ellipsometric parameter Ψ result by the inversed calculation;

FIG. 10 is a graph showing an exemplary ellipsometric parameter Δ result by the inversed calculation;

FIG. 11 is a graph showing a thickness result by the inversed calculation;

FIG. 12 is a graph showing a correlation between input Ψ and extracted Ψ when θᵢ Error=±0.01°;

FIG. 13 is a graph showing a correlation between input Δ and extracted Δ when θᵢ Error=±0.01°;

FIG. 14 is a graph showing a correlation between input thickness and extracted thickness in the case when θᵢ Error=±0.01°;

FIG. 15 is a graph showing a correlation between input 4′ and extracted IP when Phase Error=±0.01°;

FIG. 16 is a graph showing a correlation between input A and extracted A when Phase Error=±0.01°;

FIG. 17 is a graph showing a correlation between input thickness and extracted thickness when Phase Error=±0.01°;

FIG. 18 is a graph showing a correlation between input Ψ and extracted Ψ when θᵢ Error=±0.01 and the Phase Error=±0.01°;

FIG. 19 is a graph showing a correlation between input Δ and extracted Δ when θᵢ Error=±0.01 and the Phase Error=±0.01*;

FIG. 20 is a graph showing a correlation between input thickness and extracted thickness when θᵢ Error=±0.01 and the Phase Error=±0.01°;

FIG. 21 is a graph showing experimental results of measured Φ₁ (deg);

FIG. 22 is a graph showing the correlation of simulated Φ₁ and measured Φ₁;

FIG. 23 is a graph showing experimental results of measured Φ₂ (deg);

FIG. 24 is a graph showing the correlation of simulated Φ₂ and measured Φ₂;

FIG. 25 is a graph showing experimental results of measured Ψ (deg);

FIG. 26 is a graph showing the correlation of simulated Ψ and measured Ψ;

FIG. 27 is a graph showing experimental results of measured Δ (deg);

FIG. 28 is a graph showing the correlation of simulated Δ and measured Δ;

FIG. 29 is a graph showing experimental results of measured thickness (nm); and

FIG. 30 is a graph showing the correlation of measured thickness and known thickness.

### DETAILED DESCRIPTION

Disclosed herein is an improved method and apparatus for ellipsometry that will aid in the measurement and characterization of thin films. Numerous specific details are provided such as examples of components and/or mechanisms to provide a thorough understanding of the various exemplary embodiments. One skilled in the relevant art will recognize however, that an exemplary embodiment can be practiced without one or more of the specific details, or with other apparatus, systems, assemblies, methods, components, materials, parts, and/or the like. In other instances, well-known structures, materials or operations are not specifically shown or described in detail to avoid obscuring aspects of exemplary embodiments and for the sake of clarity.

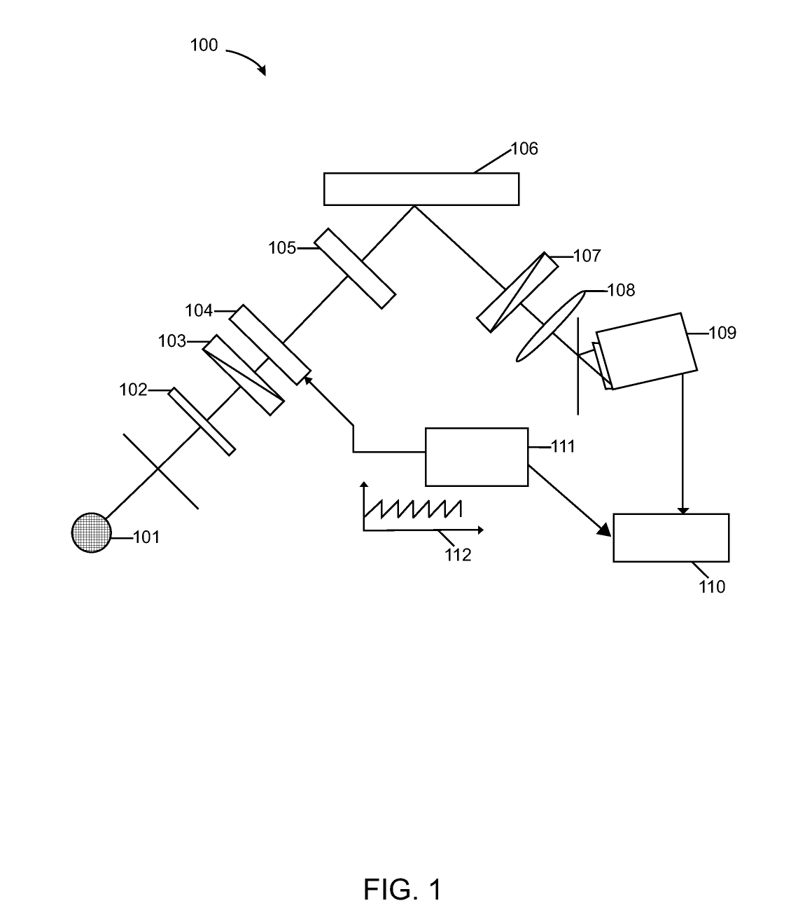

FIG. 1 illustrates an apparatus 100 for measuring thickness of a sample 106 in accordance with an exemplary embodiment. The apparatus 100 includes a light source 101, a filter 102, a polarizer 103, an electro-optic (EO) modulator 104, an optical compensator 105, the sample 106, an analyzer 107, a lens 108, a photo-detector 109, a lock-in amplifier 110 and a function generator 111. The sample 106 can be a static or a vibrating thin film.

In an exemplary embodiment, the sample 106 comprises single-layer thin film applied on a substrate. However, the sample 106 is not limited thereto, and other samples as understood by those skilled in the art may be substituted therefore without departing from the scope of the inventive concept.

In another exemplary embodiment, the sample 106 comprises multilayer isotropic thin films.

In yet another exemplary embodiment, the sample 106 comprises multilayer anisotropic thin films.

The light source 101 emits light onto the sample 106 for reflection. In an exemplary embodiment, the light source 101 used is He—Ne Laser. However, other light sources can also be used without departing from the scope of the present inventive concept.

The light emitted from the light source 101 is polarized by the polarizer 103. The polarized light received from the polarizer 103 enters the EO (electro-optic) modulator 104 which via the function generator 111 produces a modulated light.

In an exemplary embodiment, the saw tooth signal 112 is applied to the EO modulator 104 at a frequency of 1 kHz. However, other signals at other frequencies can also be used without departing from the scope of the present inventive concept.

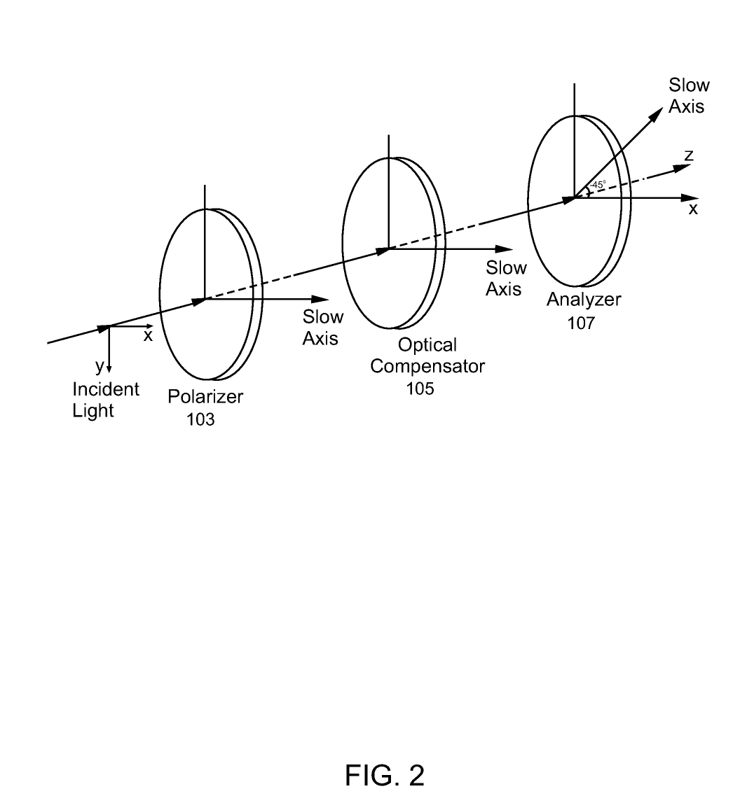

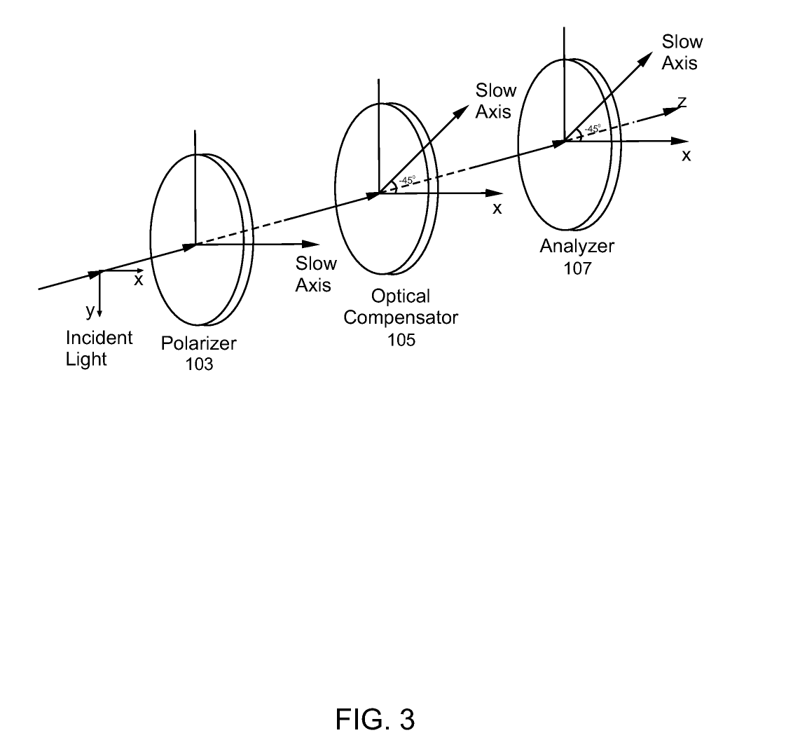

The modulated light enters the optical compensator 105 and then onto the sample 106. The slow axis of the optical compensator 105 is disposed at a first angle (that is, 0° with respect to x-axis in a first configuration as shown in FIG. 2) and at a second angle (that is, −45° with respect to x-axis in a second configuration as shown in FIG. 3). The light after reflection from the sample 106 passes through the analyzer 107 and is detected by the photo-detector 109. The signal received by the photo-detector 109 is locked in phase by using the lock-in amplifier 110 which receives a reference signal from the function generator 111.

In an exemplary embodiment, the optical compensator 105 is a quarter-wave plate. However, other optical compensators can also be used without departing from the scope of the present inventive concept.

FIG. 2 and FIG. 3 illustrate two configurations of the apparatus 100 in accordance with exemplary embodiments. FIG. 2 shows the first configuration in which the slow axis of the polarizer 103 and the optical compensator 105 (quarter-wave plate) are adjusted to 0° (the first angle) with respect to x-axis, and the slow axis of the analyzer 107 is adjusted to −45° with respect to x-axis. FIG. 3 shows the second configuration in which the slow axis of the polarizer 103 is adjusted to 0°, the slow axis of the optical compensator 105 is adjusted to −45° (the second angle) with respect to x-axis, and the slow axis of the analyzer 107 is adjusted to −45°, respectively with respect to x-axis.

In the first configuration of the apparatus 100, the light vector (E₁) of the light emerging from the photo-detector 109 is determined by using following equation:

$$\begin{matrix}{E}_{1} = A ( - {45}^{°} ) \cdot S ( Ψ , Δ ) \cdot Q ( {0}^{°} ) \cdot EO ( - {45}^{°} ) \cdot P ( {0}^{°} ) \cdot {E}_{in} \\ = \frac{1}{2} [ \begin{matrix}1 & - 1 \\ - 1 & 1\end{matrix} ] [ Sample ] [ \begin{matrix}1 & 0 \\ 0 & - i\end{matrix} ] \\ [ \begin{matrix}cos \frac{ω t}{2} & i sin \frac{ω t}{2} \\ i sin \frac{ω t}{2} & cos \frac{ω t}{2}\end{matrix} ] [ \begin{matrix}{E}_{0} \\ 0\end{matrix} ] {e}^{i {ω}_{0} r}\end{matrix} \qquad ( Equation 1 )$$

where E₀ is the amplitude of the incident electric field, P(0°) represents the Jones matrix of the polarizer 103 aligned with x-axis, Q(0°) represents the Jones matrix of the optical compensator 105, whose slow axis is aligned with x-axis, and S(Ψ,Δ) represents the Jones matrix of the sample 106. Furthermore, E₀(−45°, ωt) represents the Jones matrix of the EO modulator 104 driven by a saw tooth voltage waveform with an angular frequency ω and its slow axis is oriented at −45° related to the x-axis, and A(−45°) represents the Jones matrix of the analyzer 107 whose transmission axis forms an angle −45° with the x-axis.

As a result, the intensity of the detected signal is given by following equation:

I₁=I_{dc}(1+sin 2Ψ*cos Δ*sin ωt+(−cos 2Ψ)*cos ωt)=I_{dc}+R₁ sin(ωt+Φ₁) (Equation 2)

where I_{dc}=E₀²/4 is the dc component of the output intensity, and E₀² is the intensity of the input light. R₁ represents the amplitude, and Φ₁ represents the first phase. The first phase Φ₁ corresponding to the first configuration is obtained as:

$$\begin{matrix}{I}_{1} = {I}_{dc} ( 1 + sin 2 Ψcos Δ sin ω t + ( - cos 2 Ψ ) cos ω t ) \\ = {I}_{dc} + {R}_{1} sin ( ω t + {Φ}_{1} ) \\ = {I}_{dc} + {I}_{dc} \sqrt{{sin}^{2} 2 {Ψcos}^{2} Δ + {( - cos 2 Ψ )}^{2}} sin \\ ( ω t + {tan}^{- 1} ( \frac{- cos 2 Ψ}{sin 2 Ψ cos Δ} ) ) \\ = {I}_{dc} + {I}_{dc} \sqrt{{sin}^{2} 2 {Ψcos}^{2} Δ + {( - cos 2 Ψ )}^{2}} sin \\ ( ω t + {tan}^{- 1} ( - ( cot 2 Ψ ) ( sec Δ ) ) )\end{matrix} \\ ⇒ {Φ}_{1} = {tan}^{- 1} ( - ( cot 2 Ψ ) ( sec Δ ) ) \qquad ( Equation 3 )$$

In the second optical configuration of the ellipsometry apparatus 100 as shown in FIG. 3, the polarizer 103 is adjusted to 0°, the optical compensator 105 (quarter-wave plate) is adjusted to −45° (the second angle), and the analyzer 107 is adjusted to −45°, respectively. The light vector emerging from the configuration is determined by:

$$\begin{matrix}{E}_{2} = A ( - {45}^{°} ) \cdot S ( Ψ , Δ ) \cdot Q ( - {45}^{°} ) \cdot \\ EO ( - {45}^{°} ) \cdot P ( {0}^{°} ) \cdot {E}_{in} \\ = \frac{1}{2} [ \begin{matrix}1 & - 1 \\ - 1 & 1\end{matrix} ] [ Sample ] [ \begin{matrix}\frac{\sqrt{2}}{2} & \frac{\sqrt{2}}{2} i \\ \frac{\sqrt{2}}{2} i & \frac{\sqrt{2}}{2}\end{matrix} ] \\ [ \begin{matrix}cos \frac{ω t}{2} & i sin \frac{ω t}{2} \\ i sin \frac{ω t}{2} & cos \frac{ω t}{2}\end{matrix} ] [ \begin{matrix}{E}_{0} \\ 0\end{matrix} ] {e}^{i {ω}_{0} t}\end{matrix} \qquad ( Equation 4 )$$

As a result, the intensity of the detected signal is given by following equation:

I₂=I_{dc}[1+(cos 2Ψ)sin ωt+(−sin 2Ψ sin Δ)cos ωt]=I_{dc}+R₂ sin(ωt+Φ₂) (Equation 5)

where I_{dc}=E₀²/4 is the dc component of the output intensity, and E₀² is the intensity of the input light. R₂ represents the amplitude, and Φ₂ represents the second phase. The second phase Φ₂ is obtained as:

$$\begin{matrix}{I}_{2} = {I}_{dc} [ 1 + ( cos 2 Ψ ) sin ω t + ( - sin 2 Ψsin Δ ) cos ω t ] \\ = {I}_{dc} + {R}_{2} sin ( ω t + {Φ}_{2} ) \\ = {I}_{dc} + {I}_{dc} \sqrt{{cos}^{2} 2 Ψ + {sin}^{2} 2 {Ψsin}^{2} Δ} \\ sin ( ω t + {tan}^{- 1} ( \frac{- sin 2 Ψsin Δ}{cos 2 Ψ} ) ) \\ = {I}_{dc} + {I}_{dc} \sqrt{{cos}^{2} 2 Ψ + {sin}^{2} 2 {Ψsin}^{2} Δ} \\ sin ( ω t + {tan}^{- 1} ( - ( tan 2 Ψ ) ( sin Δ ) ) )\end{matrix} \\ ⇒ {Φ}_{2} = {tan}^{- 1} ( - ( tan 2 Ψ ) ( sin Δ ) ) \qquad ( Equation 6 )$$

As shown in Equation 3 and Equation 6, first phase Φ₁ and second phase Φ₂ are derived from the detected signal. Also, the I_{dc} term which is affected by the environmental noise or intensity fluctuation is eliminated in first phase Φ₁ and second phase Φ₂. Therefore, the two-phase detection and its calculation is not dependent on amplitude and intensity.

The ellipsometric parameters (Ψ, Δ) are determined by using the above calculated first phase Φ₁ and second phase Φ₂ as:

$$\begin{matrix}Δ = {tan}^{- 1} ( tan {Φ}_{1} \times tan {Φ}_{2} ) & ( Equation 7 ) \\ Ψ = \frac{1}{2} {tan}^{- 1} ( - \frac{tan {Φ}_{2}}{sin Δ} ) & ( Equation 8 )\end{matrix}$$

The two phase-modulated ellipsometry described above is a full-range measurement, because the range of Δ is defined before being understood whether the value of 2Ψ is smaller than 90° or not. The range of 2Ψ is defined from the Equation 5, and the term I_{dc} cos 2Ψ is determined whether it is positive or not. If the value of 2Ψ<90°, measured second phase Φ₂<0, and measured first phase Φ₁<0, then Δ is located at I-quadrant. If the value of 2Ψ<90°, measured second phase Φ₂<0, and measured first phase Φ₁>0, then Δ is located at II-quadrant. If the value of 2Ψ<90°, measured second phase Φ₂>0, and measured first phase Φ₁>0, then Δ is located at the III-quadrant. If the value of 2Ψ<90°, measured second phase Φ₂>0, and measured first phase b<0, then Δ is located at the IV-quadrant. If the value of 2Ψ>90°, measured second phase Φ₂>0, and measured first phase Φ₁>0, then Δ is located at the I-quadrant. If the value of 2Ψ>90°, measured second phase Φ₂>0, and measured first phase Φ₁<0, then Δ is located at II-quadrant. If the value of 2Ψ>90°, measured second phase Φ₂<0, and measured first phase (1), <0, then Δ is located at the III-quadrant. If the value of 2Ψ>90°, measured second phase Φ₂<0, and measured first phase Φ₁>0, then Δ is located at IV-quadrant. Thus, a full scale (i.e. 0˜360°) measurement of ellipsometric parameters (Ψ and Δ) is obtained, and hence a full-range (i.e. 0°˜180°) measurement of the optical properties is achieved.

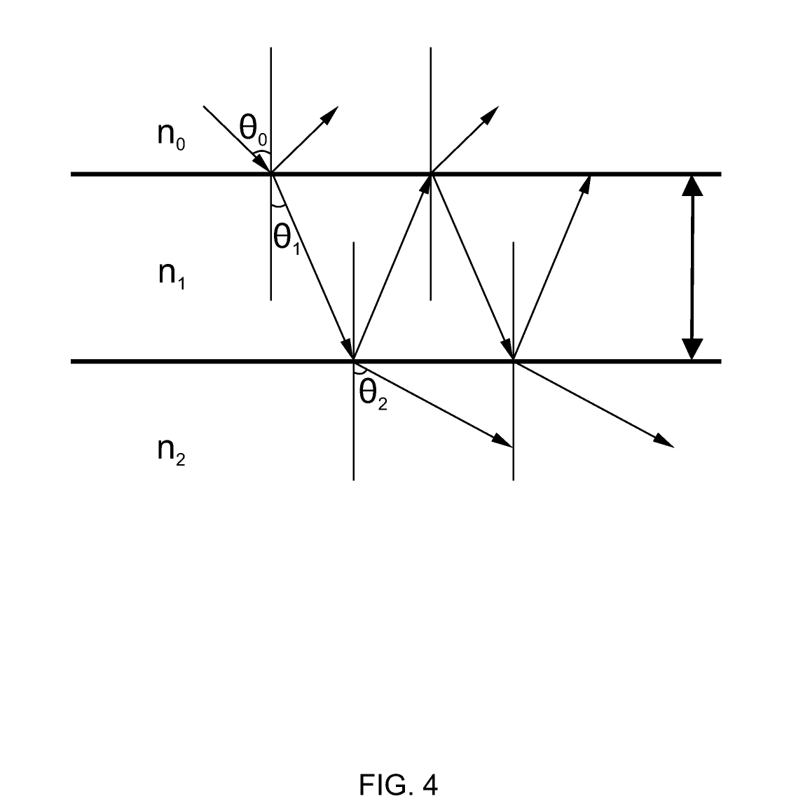

The ellipsometric parameters calculated from Equation 7 and Equation 8 above are used to combine the Fresnel equations (for s- and p-polarized waves). Thus the equation is obtained:

$$( {r}_{12 , p} {r}_{01 , s} {r}_{12 , s} - {r}_{01 , p} {r}_{12 , p} {r}_{12 , s} ( tan {Ψe}^{i Δ} ) ) {X}^{2} + ( {r}_{12 , p} + {r}_{01 , p} {r}_{01 , s} {r}_{12 , s} - {r}_{12 , s} ( tan {Ψe}^{iΔ} ) - {r}_{01 , p} {r}_{12 , p} {r}_{12 , s} ( tan {Ψe}^{i Δ} ) ) X + ( {r}_{01 , p} - {r}_{01 , s} ( tan {Ψe}^{i Δ} ) ) = 0 \qquad ( Equation 9 )$$

where rⱼₖ (tⱼₖ) is the amplitude reflection (transmission) coefficient at each interface as illustrated in FIG. 4.

θ₀, θ₁ are the angles which the incident rays and the refracted rays make to the normal of the interface respectively, θ₂ is the angle which the ray entering the medium (with refractive index n₂) makes to the normal of the interface as shown in FIG. 4.

$$\begin{matrix}{r}_{jk , p} = \frac{{N}_{k} cos {θ}_{j} - {N}_{j} cos {θ}_{k}}{{N}_{k} cos {θ}_{j} + {N}_{j} cos {θ}_{k}} \cdot {r}_{jk , 2} = \frac{{N}_{j} cos {θ}_{j} - {N}_{k} cos {θ}_{k}}{{N}_{j} cos {θ}_{j} + {N}_{k} cos {θ}_{k}} & ( Equation 10 ) \\ {i}_{jk , p} = \frac{2 {N}_{j} cos {θ}_{j}}{{N}_{k} cos {θ}_{j} + {N}_{j} cos {θ}_{k}} \cdot {t}_{jk , 2} = \frac{2 {N}_{j} cos {θ}_{j}}{{N}_{j} cos {θ}_{j} + {N}_{k} cos {θ}_{k}} & ( Equation 11 )\end{matrix}$$

where Nⱼ and Nₖ are refractive indices of media.

$$X = ( {e}^{- \frac{4 π i}{λ}} {n}_{1} cos {θ}_{1} D ) \qquad ( Equation 12 )$$

where n₁ is refractive index of medium.

The thickness of the thin film can be calculated by solving the Equation 9, and the thickness (D) is determined by:

$$D = \frac{m π + i ( ln \vert X \vert + i {θ}_{x} )}{\frac{4 π}{λ} {n}_{1} cos {θ}_{1}} \qquad ( Equation 13 )$$

where m is the order of the thickness.

In an exemplary embodiment a method for thin film thickness measurement is provided. The method comprises: emitting light from a light source; polarizing the light from the light source; modulating the polarized light; altering the polarization state of the light received from the modulator and directing the light onto the sample; polarizing the reflected light received from the sample using an analyzer; receiving the light from the analyzer for two-phase detection corresponding to two different orientations of the optical compensator.

The following simulation results show the feasibility of the proposed method in measuring ellipsometric parameters and thickness of the film. Also, if the errors of the incident angle and lock-in amplifier 110 are not too big, the error of Ψ, Δ, and thickness of the sample 106 will not be enlarged.

### Simulation Results

### Simulation Results of the Material:

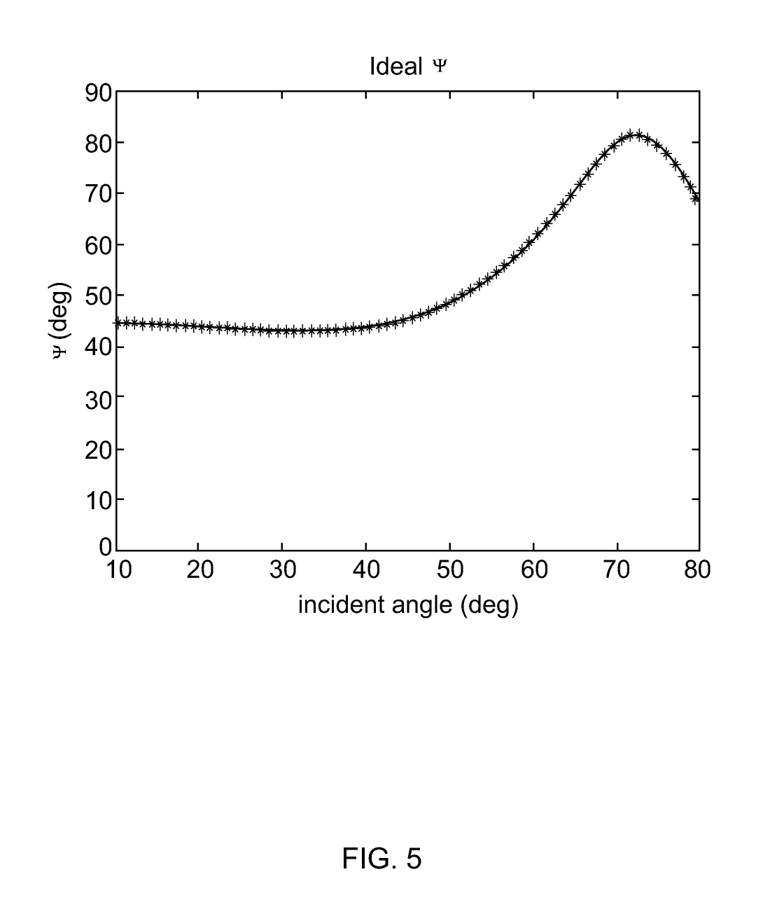

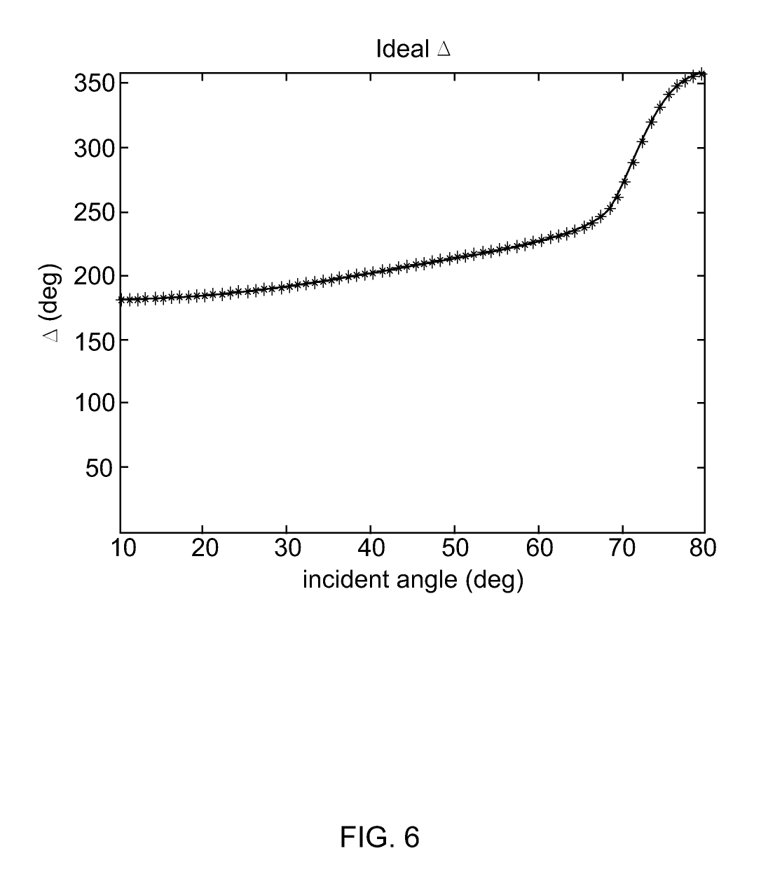

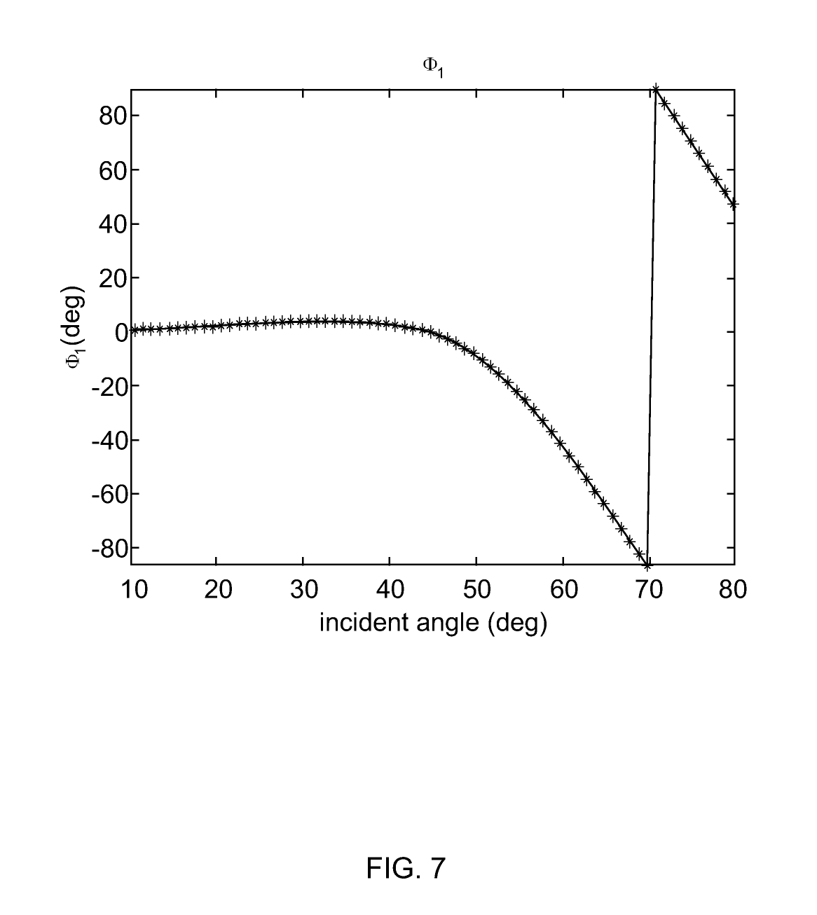

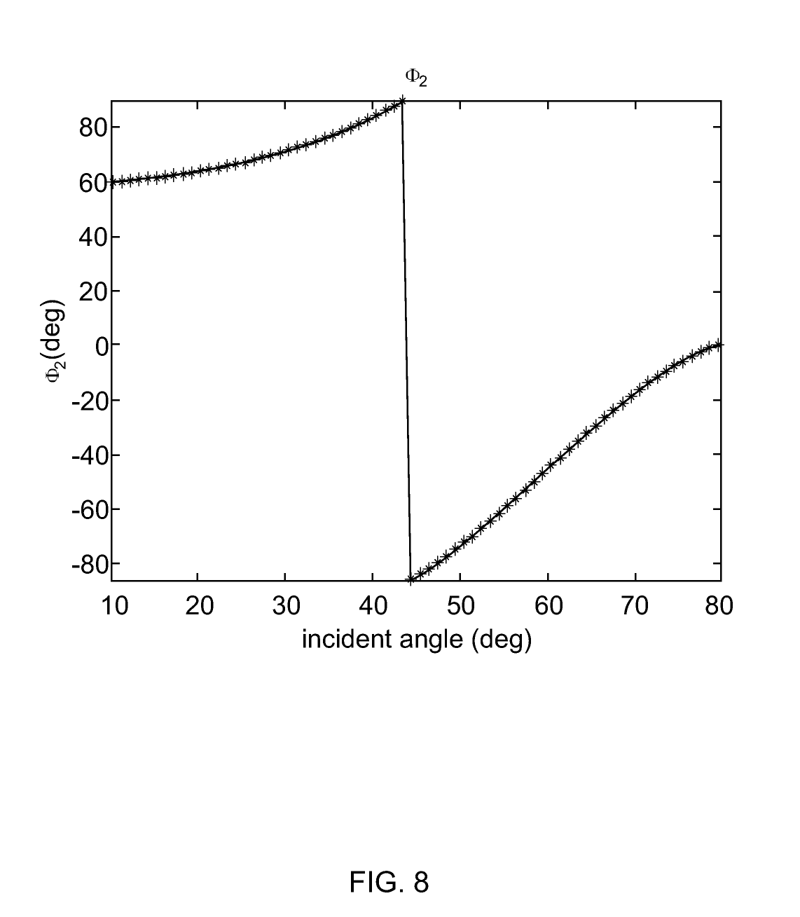

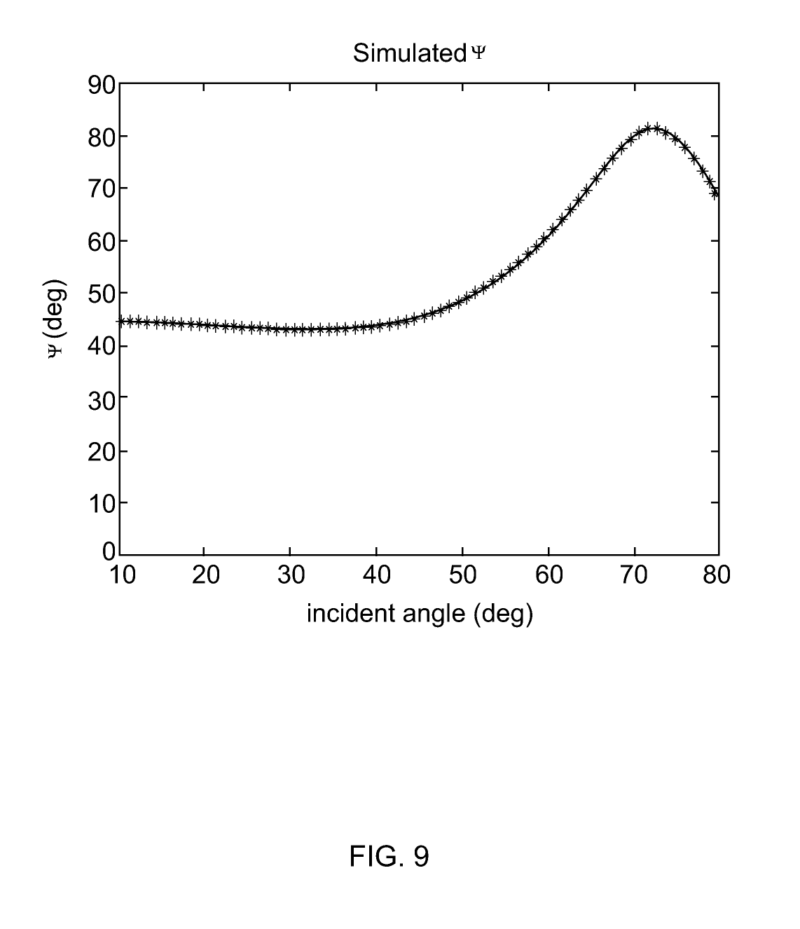

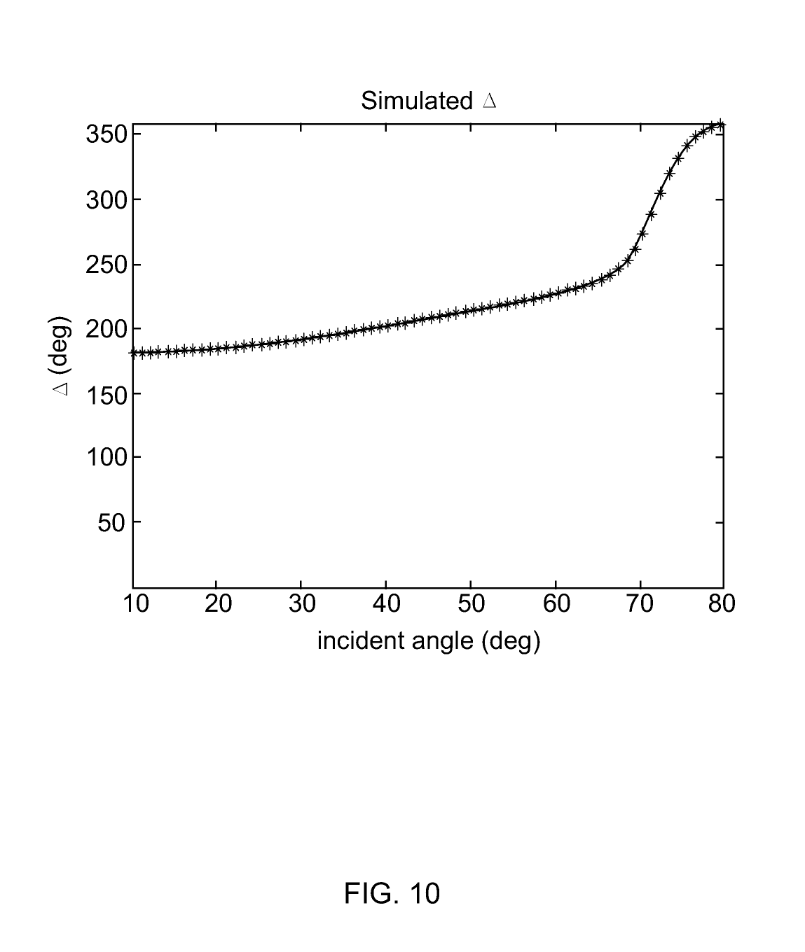

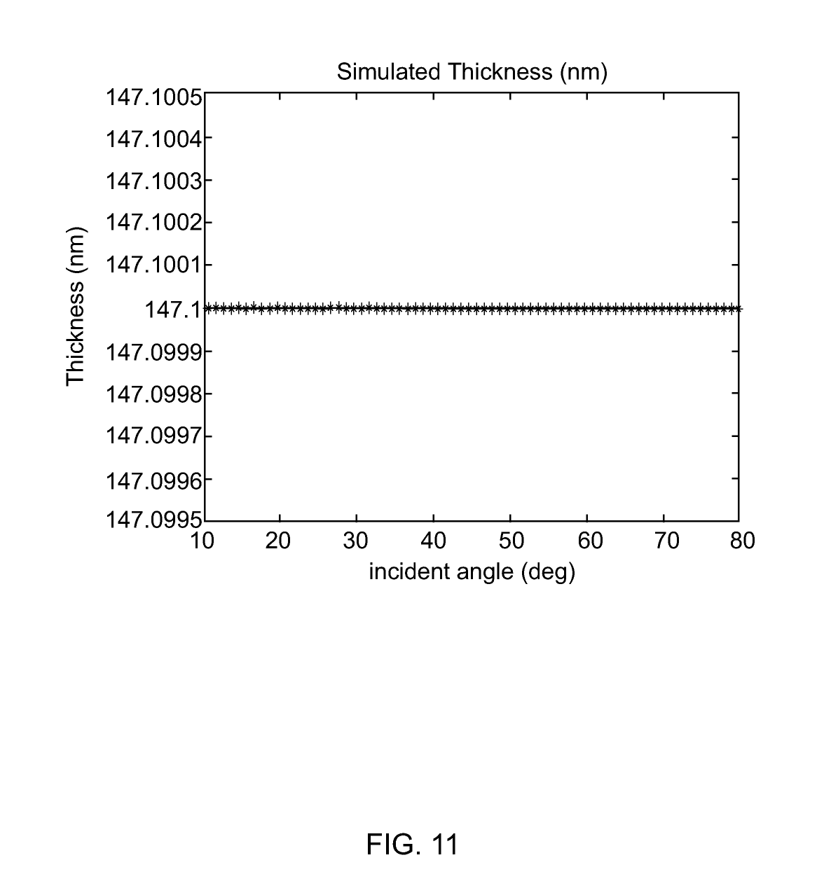

By using the properties of the sample 106, a 4×4 matrix analytical model simulates the terms including first phase Φ₁, second phase Φ₂, and the ellipsometric parameters (Ψ,Δ) corresponding to the incident angle from 10° to 80°. The Ellipsometric parameter Ψ result of the simulation is illustrated by the curve shown in FIG. 5. Similarly, The Ellipsometric parameter Δ result of the simulation is illustrated by the curve shown in FIG. 6. Then first phase Φ₁ and second phase Φ₂ results of the simulation are shown in FIG. 7 and FIG. 8 respectively and are used in the Equation 7, Equation 8 and Equation 13 to calculate the ellipsometric parameters (Ψ and Δ) and the thickness of the thin film corresponding to the incident angle from 10°˜80°, respectively. The results of the simulation for Ψ, Δ and thickness by the inversed calculation are shown in FIG. 9, FIG. 10 and FIG. 11 respectively. These figures confirm the feasibility of the signal processing system according to the invention, and it is applied to the ellipsometric parameters (Ψ, Δ) in the experiments following this section. These simulation results also show the capability of the proposed invention in measuring ellipsometric parameters and the thickness of the film.

### Simulation Results of Ψ and Δ Error Analysis

The 4×4 matrix method is used to derive theoretical output ellipsometric parameters (Ψ, Δ) and let the theoretical input of the incident angle and lock-in amplifier 110 have ±0.01° error in variations. Inserting the ±0.01° error of the parameters with a simulated error into the algorithm deduced by 4×4 matrix method, the error of algorithm is understood. The characteristics of the algorithm by using three different cases are mentioned: the incident angle with ±0.01° error, lock-in amplifier 110 with ±0.01° error, and both incident angle and lock-in amplifier 110 exist the ±0.01° error. The simulation shows the results of 0%˜1% error-analysis by using the material illustrated in the subsection above with regard to the 25° incident angle.

### Simulation Results of Ψ and Δ Error Analysis in θᵢ Error=±0.01°

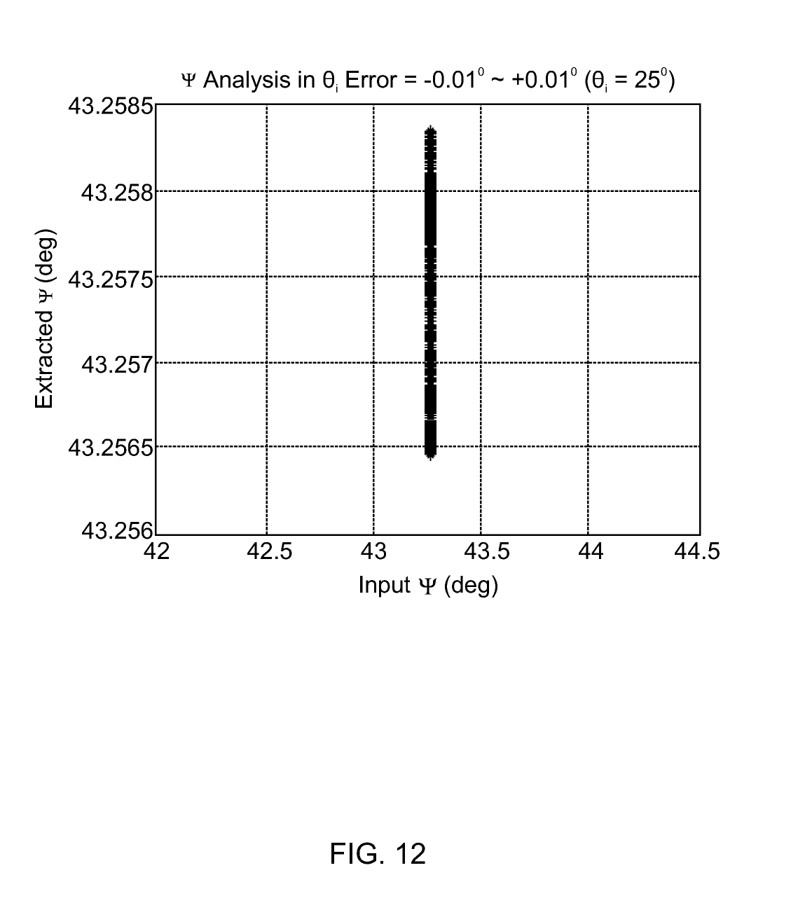

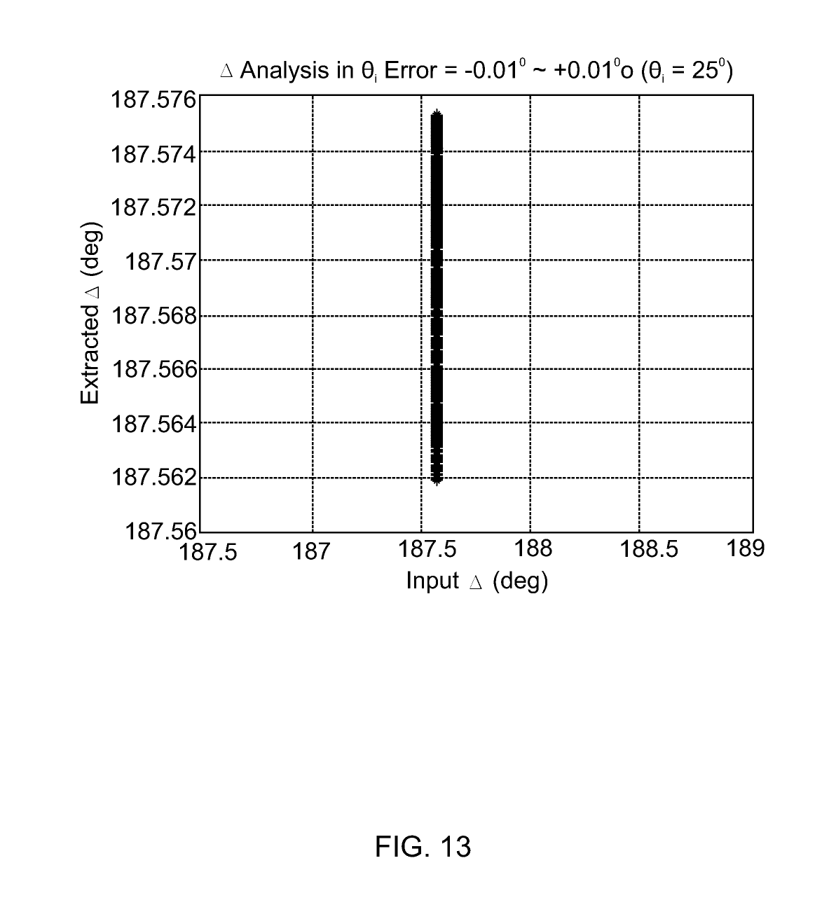

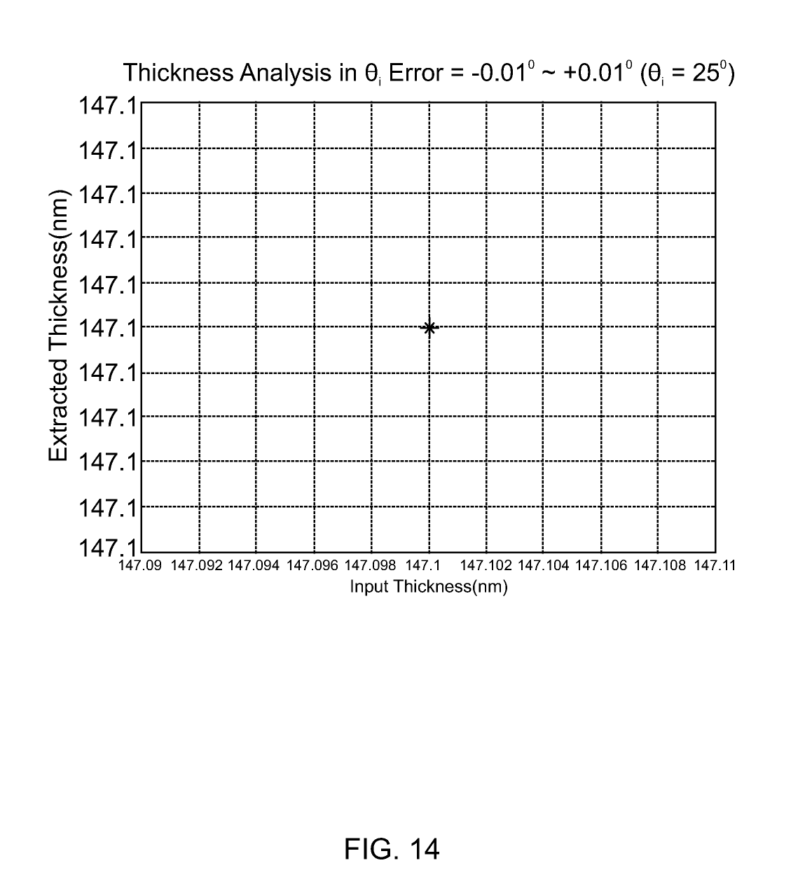

The 4×4 matrix method is used to derive theoretical output ellipsometric parameters (Ψ, Δ) and let the theoretical input of the incident angle have ±0.01° error in variations. The values of the ellipsometric parameters Ψ=43.2574°, Δ=187.5686°, thickness of the film D=147.1 nm are chosen in order to extract Ψ, Δ, D by using Equation 7, Equation 8 and Equation 13 with ±0.01° error in the incident angle. FIGS. 12, 13 and 14 show the simulated results for Ψ, Δ and D respectively. A correlation between input Ψ and extracted Ψ when θᵢ Error=±0.01 (incident angle has ±0.01° error in variations) is shown in FIG. 12. Similarly, correlation between input A and extracted Δ is shown in FIG. 13 and correlation between input thickness and extracted thickness is shown in FIG. 14. The three error bars in the three parameters, Ψ, Δ, and D, are ±(4.7276×10⁻⁴)°, ±(0.0039)°, and ±(1.1912×10⁻¹³) nm respectively.

### Simulation Results of Ψ and Δ Error Analysis in the Phase Error=±0.01°

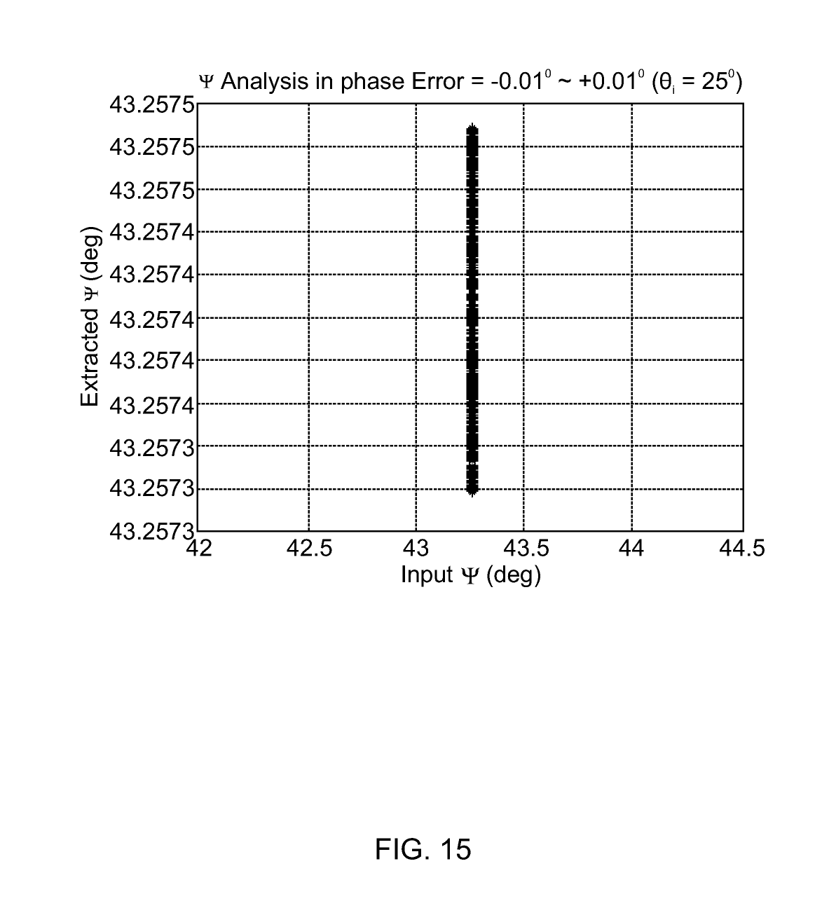

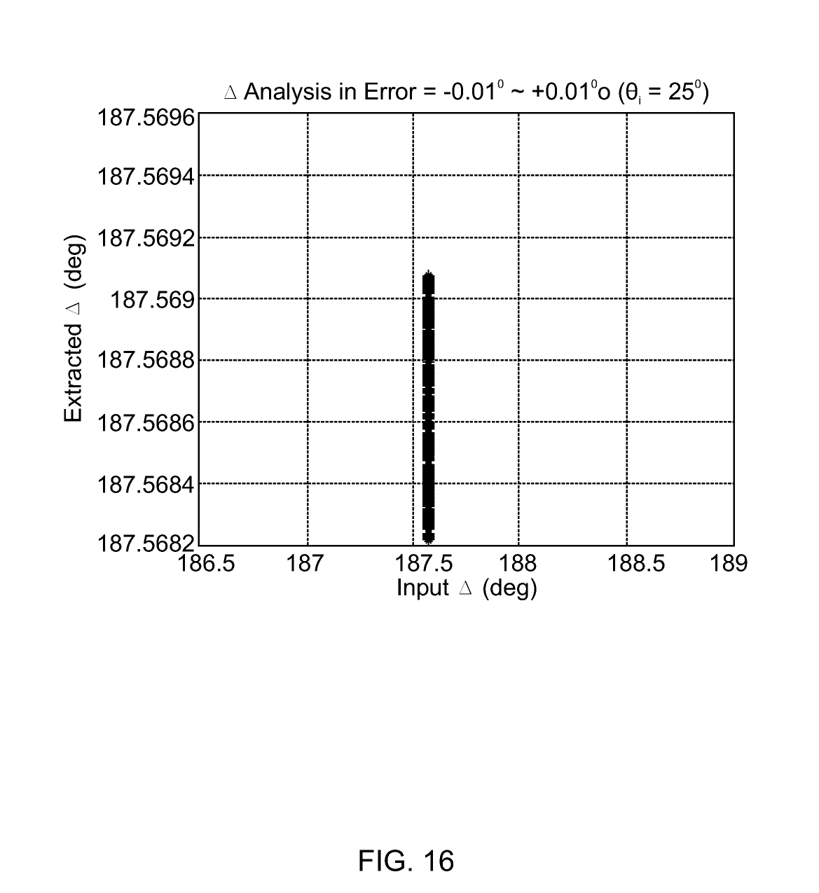

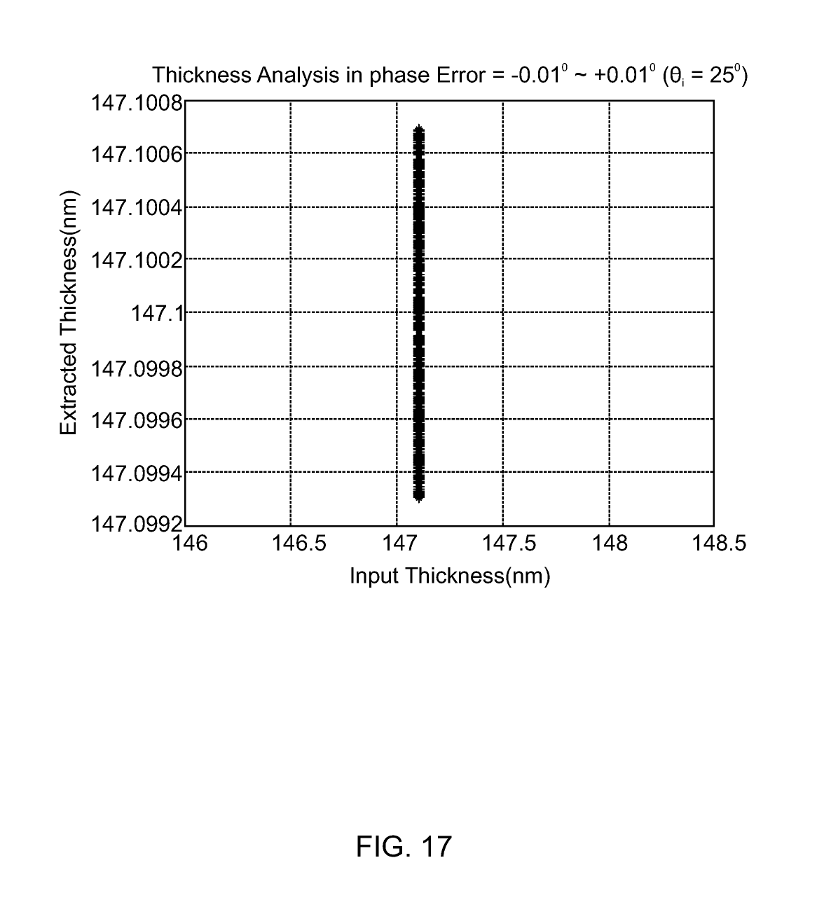

The 4×4 matrix method is used to derive theoretical output ellipsometric parameters (Ψ, Δ) and let the theoretical input of the lock-in amplifier have ±0.01° error in variations. The values of the ellipsometric parameters Ψ=43.2574°, Δ=187.5686°, and thickness of the film D=147.1 nm are chosen in order to extracte Ψ, Δ, D by using Equation 7, Equation 8 and Equation 13 with ±0.01° error in the incident angle. FIGS. 15, 16 and 17 show the simulated results for Ψ, Δ and D respectively. A correlation between input Ψ and extracted Ψ when Phase Error=±0.01° is shown in FIG. 15. Similarly, correlation between input Δ and extracted Δ is shown in FIG. 16 and correlation between input thickness and extracted thickness is shown in FIG. 17. The three error bars in the three parameters, Ψ, Δ, and D, are ±(4.4128×10⁻⁵)°, ±(2.3872×10⁻⁴)°, and ±(3.4564×10⁻⁴) nm respectively.

### Simulation Results of Ψ and Δ Error Analysis in the θᵢ Error=±0.01 and the Phase Error=±0.01°

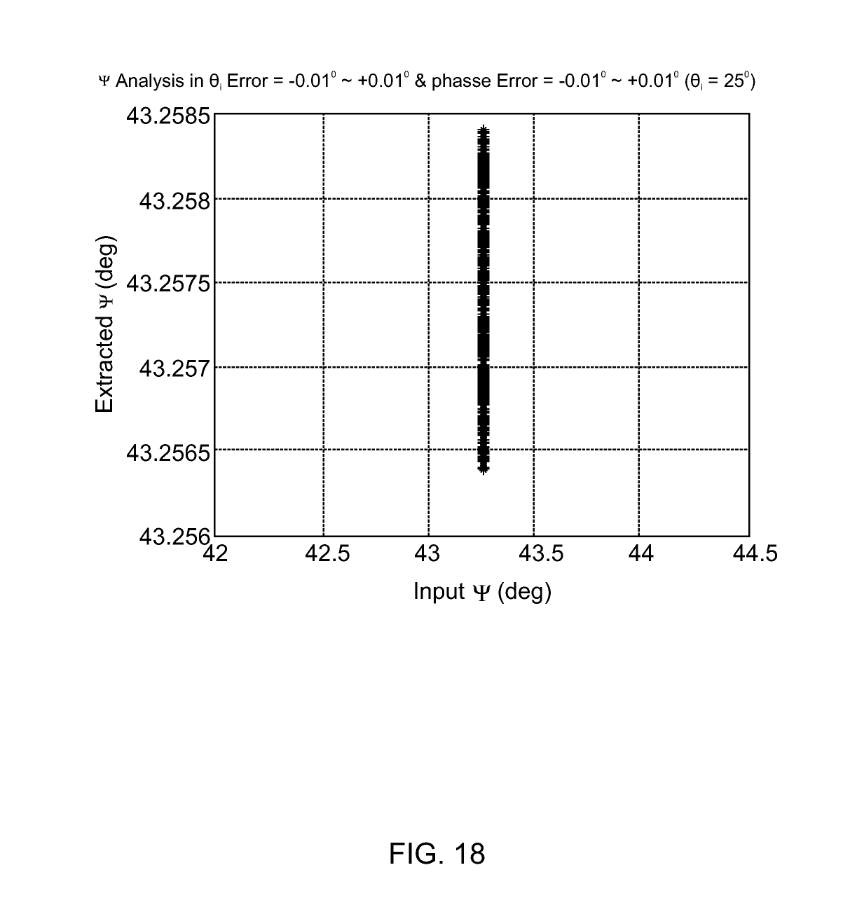

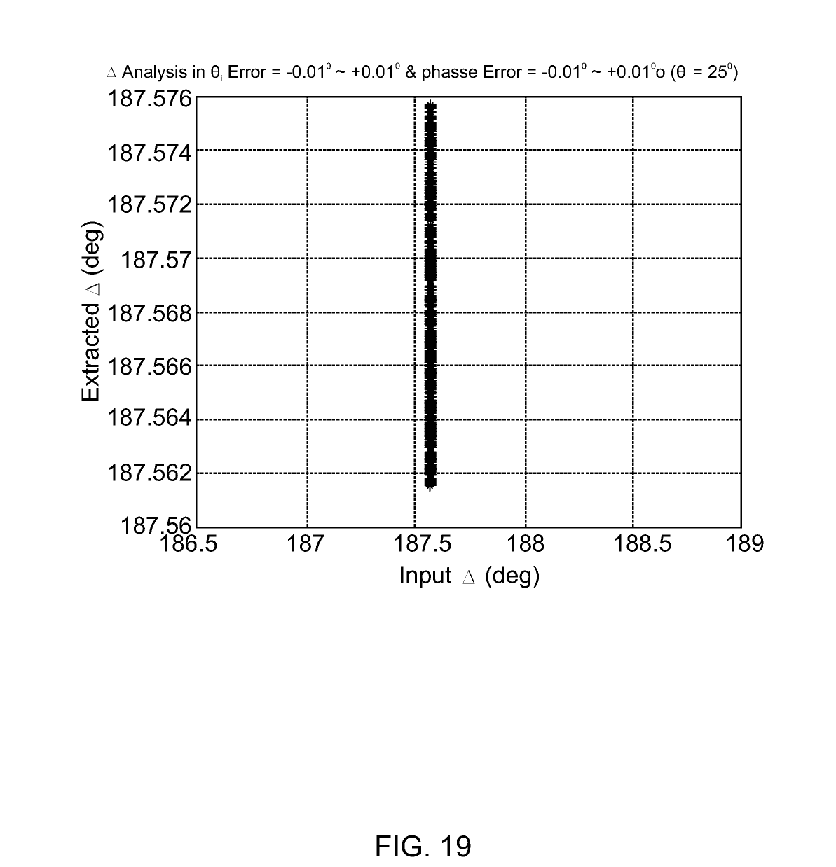

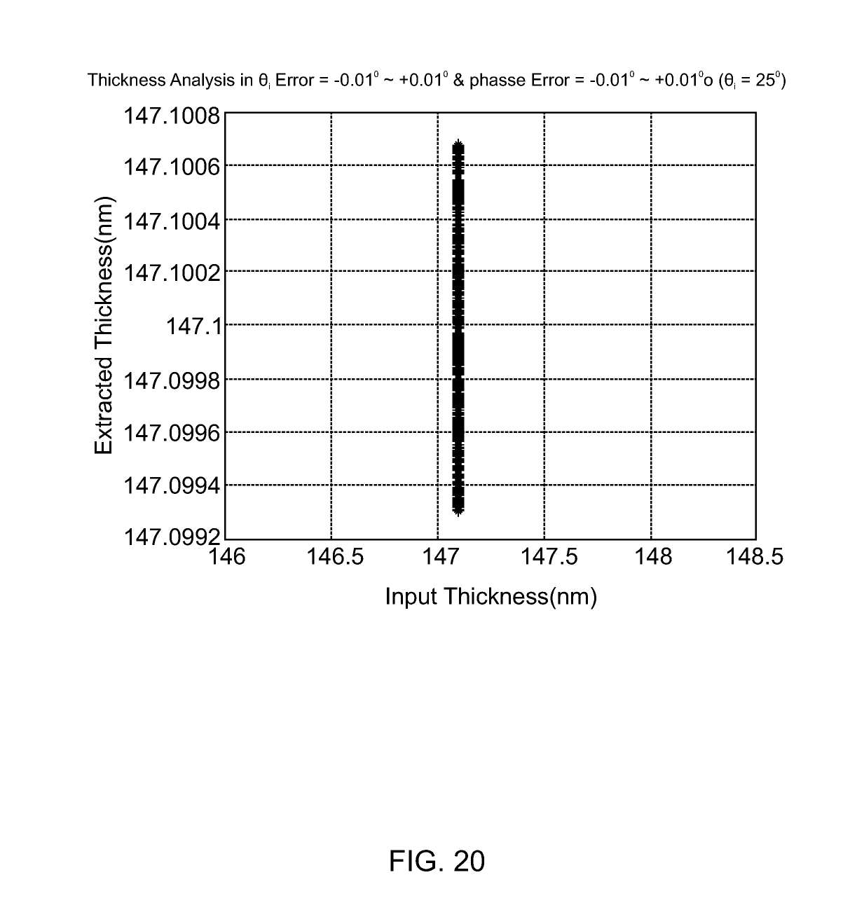

The 4×4 matrix method is used to derive theoretical output ellipsometric parameters (Ψ, Δ) and let the theoretical input of the incident angle and lock-in amplifier 110 have ±0.01° error in variations. The values of the ellipsometric parameters Ψ=43.2574°, Δ=187.5686°, and thickness of the film D=147.1 nm are chosen in order to extract Ψ, Δ, D by using Equation 7, Equation 8 and Equation 13 with ±0.01° error in the incident angle. FIGS. 18, 19 and 20 show the simulated results for Ψ, Δ and D respectively. A correlation between input Ψ and extracted Ψ when θᵢ Error=±0.01 and the Phase Error=±0.01° is shown in FIG. 18. Similarly, correlation between input Δ and extracted Δ is shown in FIG. 19 and correlation between input thickness and extracted thickness is shown in FIG. 20. The three error bars in the three parameters, Ψ, Δ, and D, are ±(4.9963×10⁻⁴)°, ±(0.0071)°, and ±(3.4679×10⁻⁴) nm respectively.

These simulation results have shown that inserting the theoretical input of the incident angle and lock-in amplifier 110 with ±0.01° error in variations into the algorithm causes the maximum error of Ψ, Δ, and thickness. It should be noticed that if the errors of the incident angle and lock-in amplifier 110 are not too large in magnitude, the error of Ψ, Δ, and thickness of the sample 106 will not be enlarged.

### Experimental Setup and Experimental Results

### Experimental Setup

The schematic illustration of the experimental setup used to measure the ellipsometric parameters of the sample 106 is shown in FIG. 1. In FIG. 2, the polarizer 103 is adjusted to 0°, the quarter-wave plate (optical compensator 105) is adjusted to 0° and the analyzer 107 is adjusted to −45°. In FIG. 3, the polarizer 103 is adjusted to 0°, the quarter-wave plate (optical compensator 105) is adjusted to −45° and the analyzer 107 is adjusted to −45°. Silicon substrate coated with the SiO₂ thin film (147.1 nm) is taken as the sample 106. The sample stage is rotated at the angle which is equivalent to the incident angle. In the system, the He—Ne laser (SL 02/2, SIOS Co.) is used as a light source 101. The frequency of the saw tooth signal from a function generator 111 applied to the EO modulator 104 is 1 kHz. The experimental setup includes two sheet polarizers (Sigma Koki, Model: SPF-30C-32) with extinction ratios of 5×10⁶, one quarter wave plate (Sigma Koki, Model: WPQ-6328-4M). The laser beam passes sequentially through a polarizer 103, electro-optic (EO) modulator 104, the quarter-wave plate (optical compensator 105), reflected by the sample 106, and an analyzer 107 before being incident on the photo-detector 109. The signal received by the photo-detector 109 could be locked in phase by using the lock-in amplifier 110 (SRS, Model: SR-830). It should be noticed that the incident light is perpendicular to the sample stage before measuring the sample 106 to calibrate the optical path and the inclination of the sample stage. Furthermore, one should assure the light reflected the sample stage matches the incident laser spot absolutely. This is an important calibration step for the measurement.

### Experimental Results

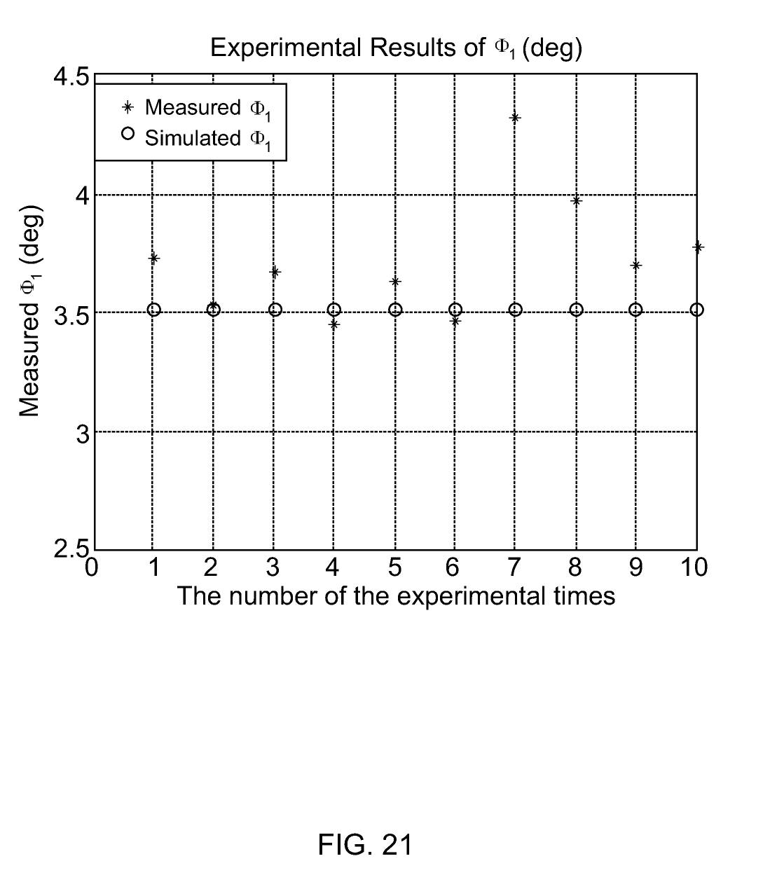

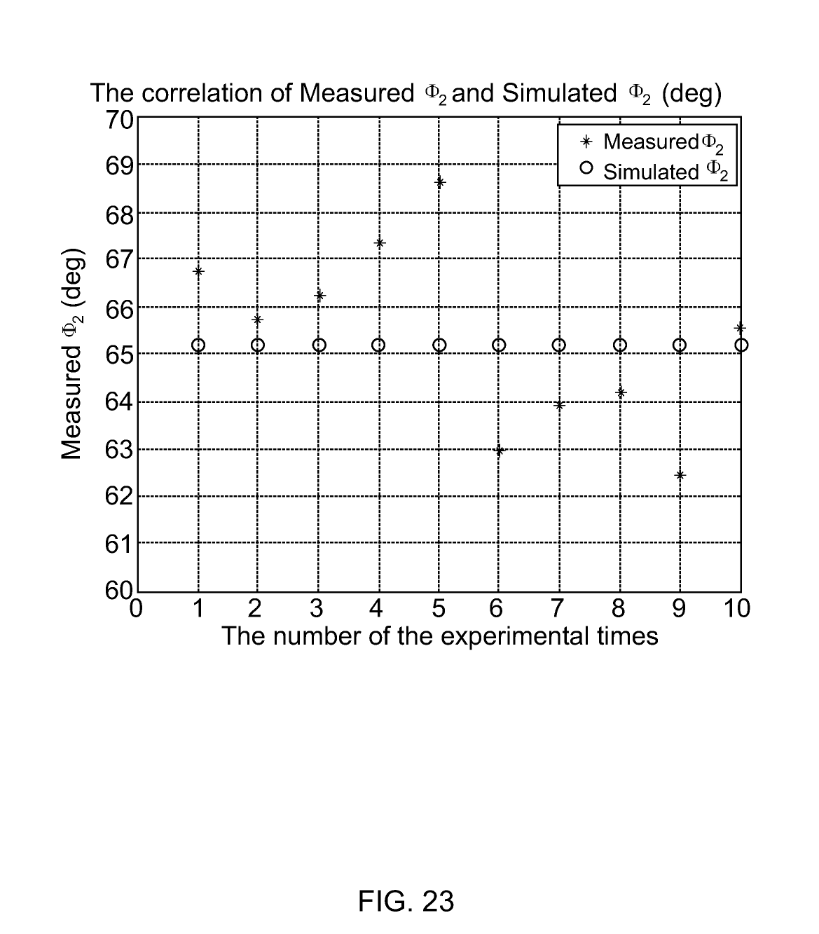

Parameters of the sample 106 are shown in Table 1. First phase Φ₁ (Equation 3) and second phase Φ₂ (Equation 6) are measured using the apparatus 100 as disclosed in the present invention. The experimental results of measured first phase Φ₁ and measured second phase Φ₂ are shown in FIG. 21 and FIG. 23. Phases corresponding to the incident angles Λᵢ=25° from the lock-in amplifier 110 are obtained and are inserted into the Equation 7, Equation 8 and Equation 13 to calculate the ellipsometric parameters (Ψ and Δ) and the thickness of the thin film. The measured phase (Φ₁ and Φ₂), the ellipsometric parameters (Ψ and Δ), and the measured thickness of the sample are shown in Table 2.

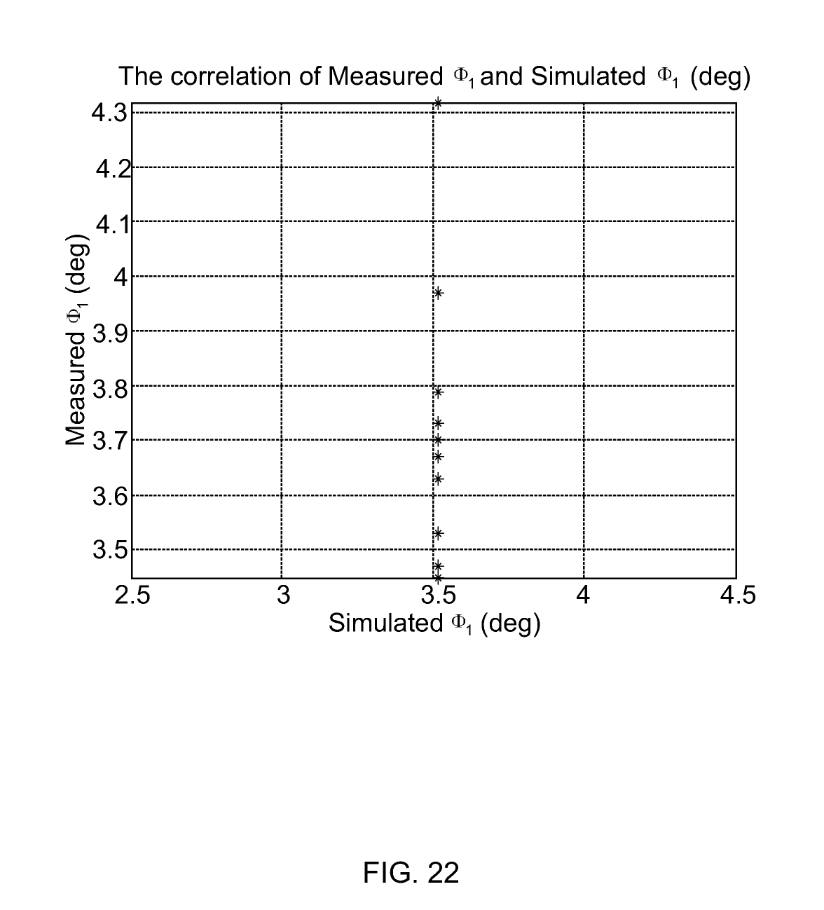

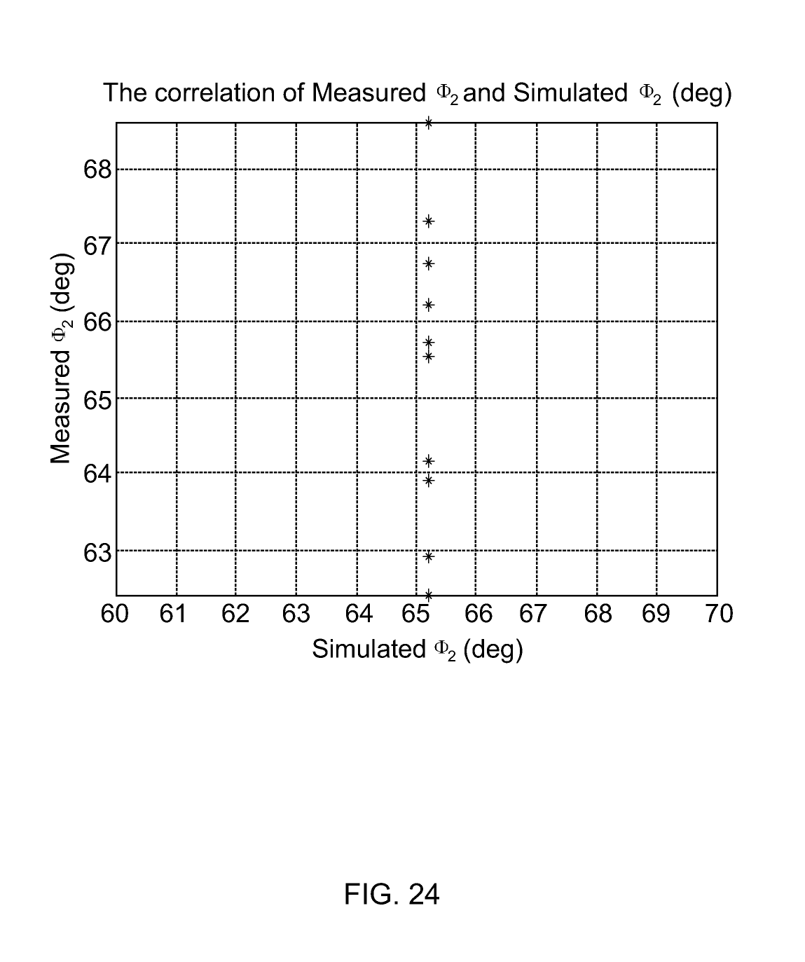

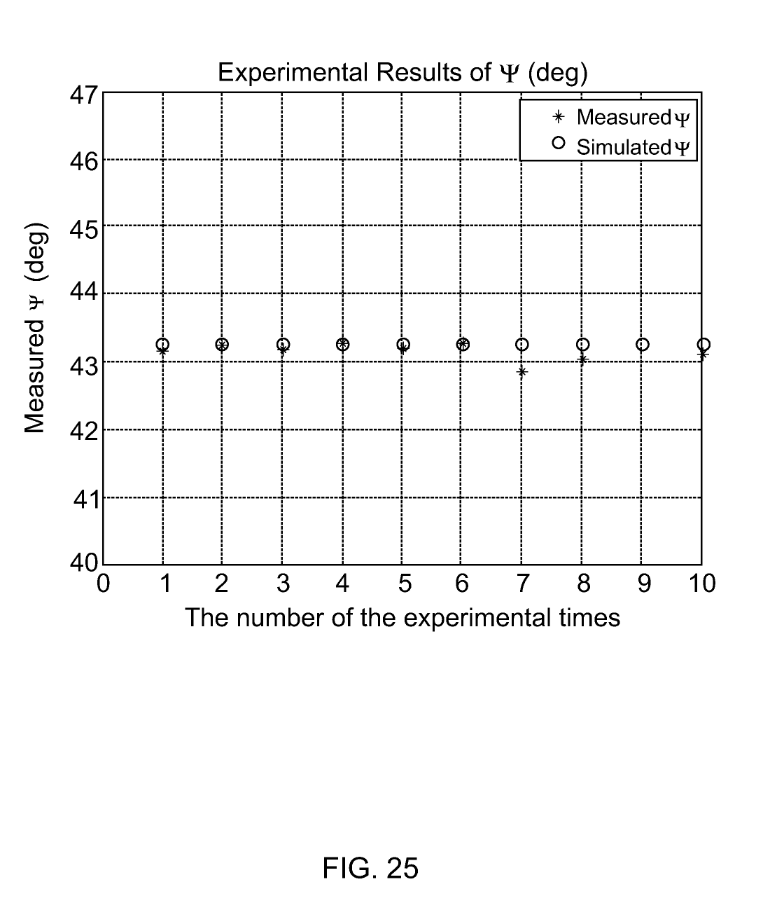

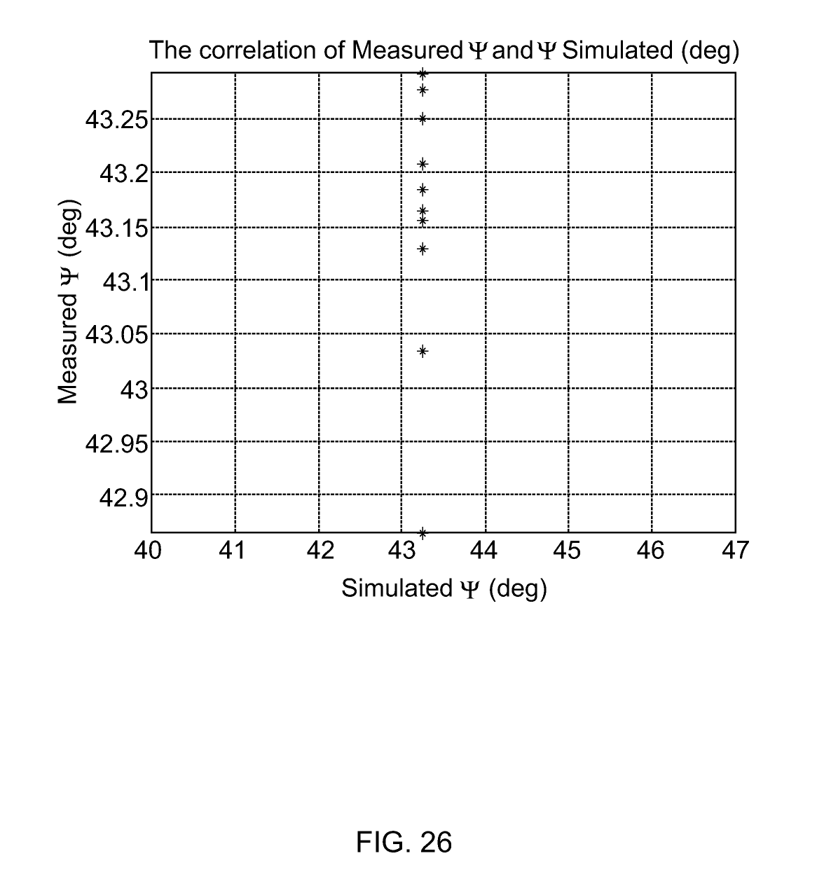

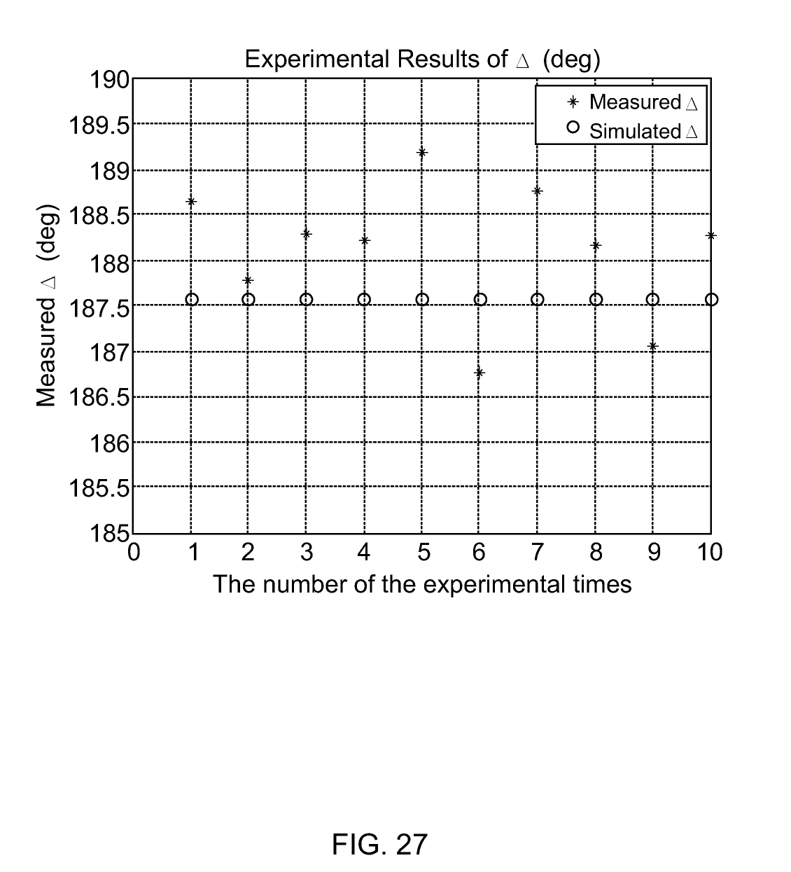

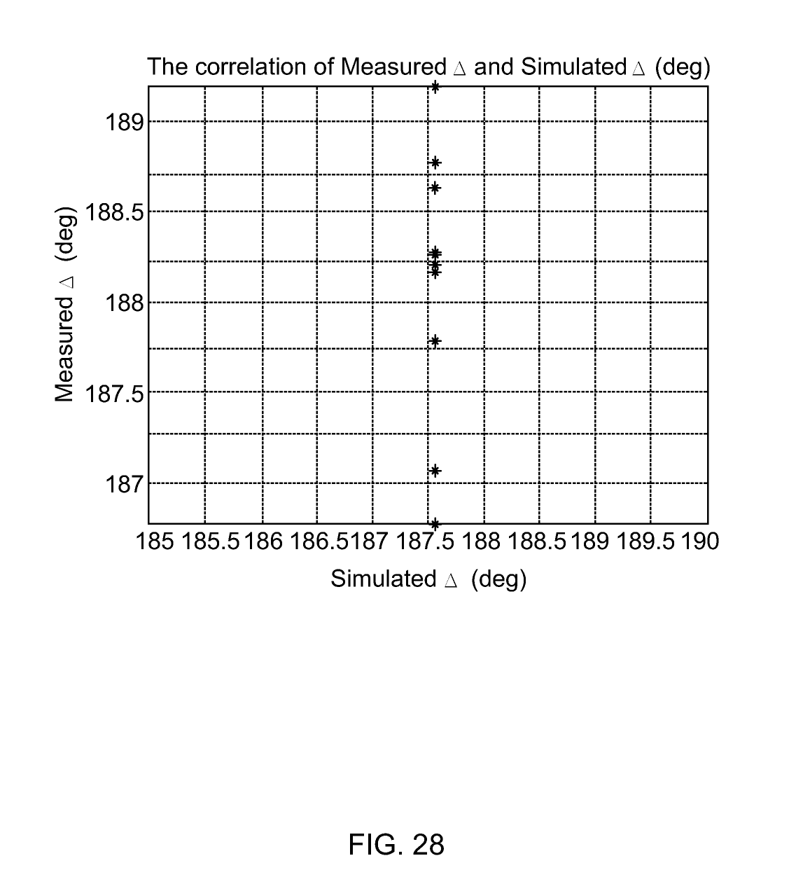

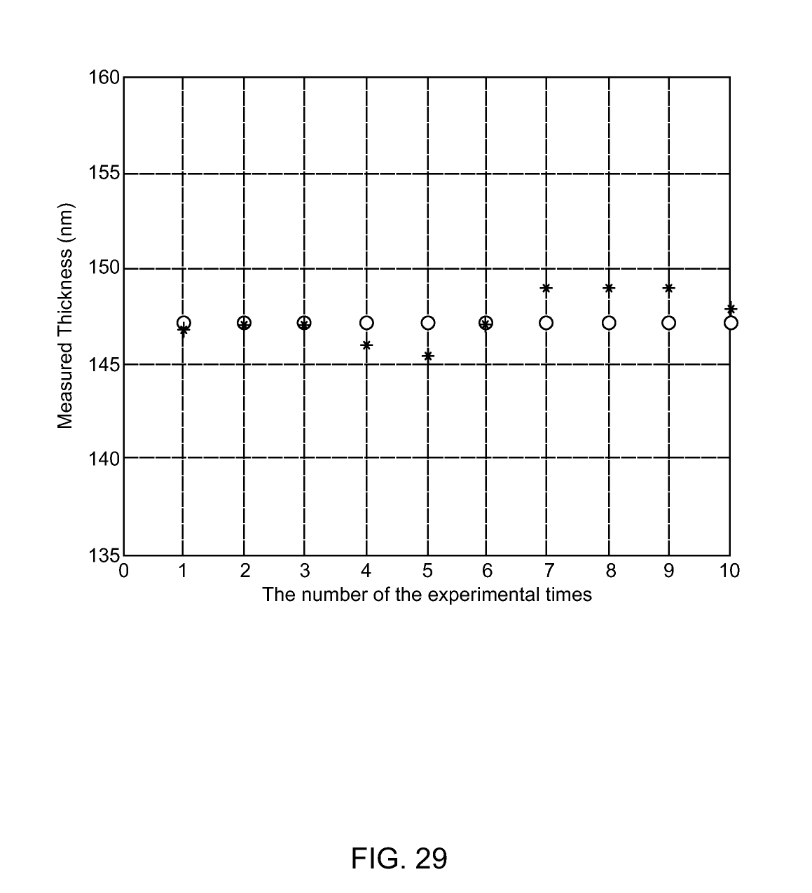

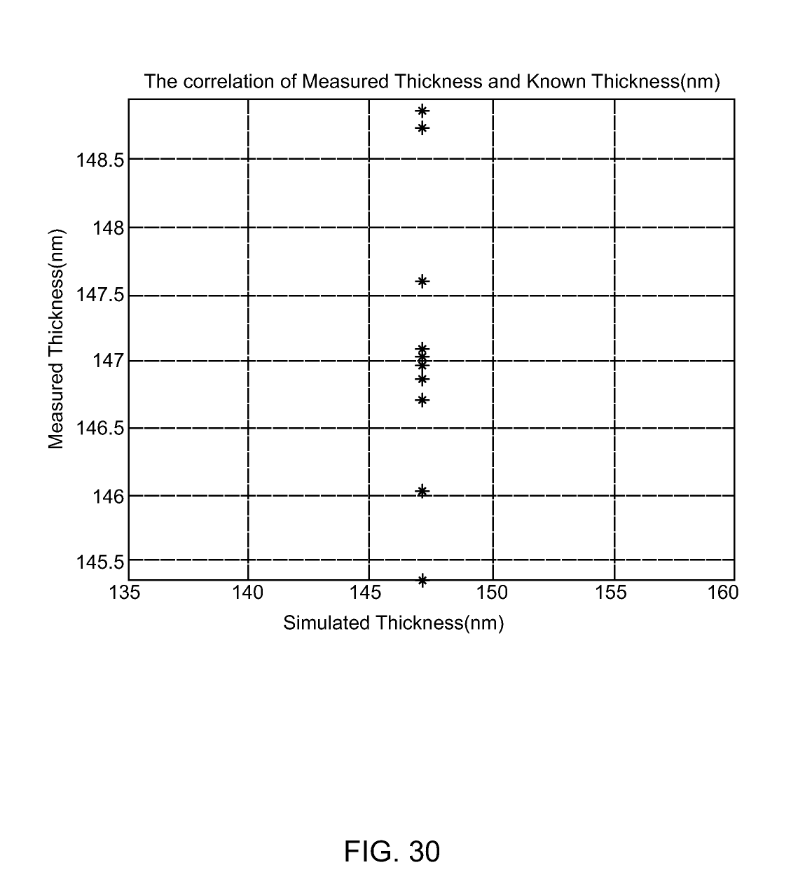

The experimental results of measured IP and measured Δ are shown in FIG. 25 and FIG. 27 respectively. Correlation between the simulated and measured values of the two phases (Φ₁ and Φ₂), ellipsometric parameters (Ψ and Δ) and thickness is also illustrated in the drawings. The correlation of simulated and measured values of Φ₁ and Φ₂ is shown in FIG. 22 and FIG. 24 respectively. The correlation of simulated and measured values of ellipsometric parameters, Ψ and Δ is shown in FIG. 26 and FIG. 28. The experimental results of measured thickness are shown in FIG. 29 and the correlation of measured thickness and known thickness is shown in FIG. 30.

The experimental results have shown that the standard deviation of Ψ is 0.1313°, the experimental deviation of Δ is 0.6829°, and the experimental deviation of thickness is 0.9355 (nm).

TABLE 1
PARAMETERS OF SAMPLE

| Parameters | Values |
|---|---|
| SiO2 Thickness | 147.1 nm |
| SiO2 Refractive Index | 1.464 |
| Si Refractive Index | 3.88114 |
| Simulated Ψ (deg) | 43.2574 |
| Simulated Δ(deg) | 187.5686 |
| Simulated Φ₁ (deg) | 3.5157 |
| Simulated Φ₂ (deg) | 65.1847 |

TABLE 2

| Data Number | Φ₁ (deg) | Φ₂ (deg) | Ψ (deg) | Δ (deg) | D (nm) |
|---|---|---|---|---|---|
| 1 | 3.73 | 66.75 | 43.156 | 188.6283 | 146.71 |
| 2 | 3.53 | 65.72 | 43.2512 | 187.787 | 146.96 |
| 3 | 3.67 | 66.21 | 43.1841 | 188.2783 | 147.02 |
| 4 | 3.45 | 67.31 | 43.2926 | 188.205 | 146.03 |
| 5 | 3.63 | 68.60 | 43.2083 | 189.1953 | 145.36 |
| 6 | 3.47 | 62.93 | 43.2771 | 186.7664 | 146.87 |
| 7 | 4.32 | 63.91 | 42.8652 | 188.7697 | 148.95 |
| 8 | 3.97 | 64.17 | 43.0350 | 188.1590 | 148.75 |
| 9 | 3.70 | 62.43 | 43.1640 | 187.0604 | 148.87 |
| 10 | 3.78 | 65.54 | 43.1296 | 188.2641 | 147.59 |
| Standard | 0.2600 | 1.9755 | 0.1273 | 0.7421 | 1.2237 |
| deviation | | | | | |

While the exemplary embodiments have been disclosed for illustrative purposes, those skilled in the art will appreciate that various modifications and other embodiments are possible, without departing from the scope and spirit of the present inventive concept as defined by the appended claims.

We claim:

1. An apparatus for determining a thickness of a sample, the apparatus comprising:
a polarizer configured to receive and polarize filtered light received from a light source;
a modulator configured to modulate the polarized light in accordance with a signal received from a function generator;
an optical compensator configured to alter a polarization state of the modulated light, and configured to direct the light onto the sample; and
a detector configured to receive light from the sample via an analyzer and to determine a first phase of detected light when a slow axis of said optical compensator is disposed at a first angle with respect to a slow axis of the polarizer and a slow axis of the analyzer, and to determine a second phase when said optical compensator is disposed at said second angle with respect to the slow axis of the polarizer and the slow axis of the analyzer,
wherein the thickness is calculated based on said first phase and said second phase.

2. The apparatus of claim 1, wherein the sample comprises a multilayer isotropic thin film.

3. The apparatus of claim 1, wherein the sample comprises a multilayer anisotropic thin film.

4. The apparatus of claim 1, wherein a difference between said first angle and said second angle is 45 degrees.

5. An ellipsometric apparatus for measuring a thickness of a sample, the ellipsometric apparatus comprising:
a polarizer configured to receive and polarize filtered light received from a light source;
a modulator configured to modulate the polarized light in accordance with a signal received from a function generator;
an optical compensator configured to alter a polarization state of the modulated light, and configured to direct the light onto the sample; and
a detector configured to receive light from the sample via an analyzer and to determine a first phase of detected light when a slow axis of said optical compensator is disposed at a first angle with respect to a slow axis of the polarizer and a slow axis of the analyzer, and to determine a second phase when said optical compensator is disposed at said second angle with respect to the slow axis of the polarizer and the slow axis of the analyzer,
wherein the thickness is calculated based on said first phase and said second phase.

6. The ellipsometric apparatus of claim 5, wherein the sample comprises a multilayer anisotropic thin film.

7. The ellipsometric apparatus of claim 5, wherein the sample comprises a multilayer isotropic thin film.

8. The ellipsometric apparatus of claim 5, wherein a difference between said first angle and said second angle is 45 degrees.

9. A method for determining a thickness of a sample, the method comprising:
polarizing light received from a light source;
modulating the polarized light;
altering a polarization state of the modulated light by passing the modulated light through an optical compensator;
measuring a first phase corresponding to the detected light when said optical compensator is disposed at a first angle,
measuring a second phase corresponding to the detected light when said optical compensator is disposed at a second angle;
calculating ellipsometric parameters based on said first phase and second phase; and
determining the thickness of said sample based on the ellipsometric parameters.

10. The method of claim 9, wherein the sample comprises a multilayer anisotropic thin film.

11. The method of claim 9, wherein the sample comprises a multilayer isotropic thin film.

12. The method of claim 9, wherein a difference between said first angle and said second angle is 45 degrees.
